(19) United States
(12) Patent Application Publication
(10) Pub. No.: US 2012/0061483 A1
(43) Pub. Date: Mar. 15, 2012

(54) COLD AND HOT WATER SUPPLY SYSTEM WITH IMPROVED CONTROL PART

(75) Inventor: Yeong-Chun Lee, Bucheon-si (KR)

(73) Assignee: KISEUNG METAL CO., LTD., Seoul (KR)

(21) Appl. No.: 13/321,626

(22) PCT Filed: May 20, 2010
(86) PCT No.: PCT/KR2010/003199

§ 371 Date: Nov. 21, 2011

(30) Foreign Application Priority Data
May 22, 2009 (KR) 10-2009-0045180

(51) Int. Cl. F24D 19/10; G05D 23/13; A47K 3/28; F24D 17/00; F24H 1/48

(52) U.S. Cl. 237/8 A; 237/62; 237/63; 4/596; 236/12.1

(57) ABSTRACT

Disclosed herein is a hot/cold water supply system with an improved control part. Cold water that has remained in a pipe is re-circulated through a circulating water pipe and is re-supplied into and heated by a boiler rather than being discharged out of a faucet, and the temperature of the water is adjusted in a thermo-and-geared valve to a temperature preset by a user so that water with a low temperature deviation can be supplied to the user. Further, an excessive load is prevented from being applied to the thermo-and-geared valve. Water of different temperatures preset by users can be supplied to corresponding control zones. A sudden deviation in temperature can be prevented when the boiler re-ignites. When the temperature of water reaches a preset temperature, a control panel indicates it to the user on a display and/or by providing a sound, thus making it more convenient to use.

### TECHNICAL FIELD

The present invention relates, in general, to hot/cold water supply systems with improved control parts and, more particularly, to a hot/cold water supply system for washstands or other water facilities installed in apartments, studio apartments, hotels, dwelling houses, saunas, public bathrooms, etc., which is configured such that cold water that has remained in a pipe re-circulates through a circulating water pipe and is re-supplied into and heated by a boiler rather than being discharged out of a faucet, and the temperature of water is adjusted in a thermo-and-geared valve to a temperature preset by a user so that water with a low temperature deviation can be supplied to the user, and in which a temperature control sensor is provided on the circulating water pipe connected to a circulating-water pump so that, when the temperature of the water is set in one of a plurality of control zones, the control part detects the corresponding control zone, and when the temperature of mixed water reaches the preset temperature, the circulating-water pump stops, thus preventing excessive pressure from being applied to the thermo-and-geared valve that has already been interrupted, thereby preventing the temperature of hot water to be supplied to the user from being higher than the preset temperature, and in which a flow rate sensor is provided on a cold water supply pipe before branching out into the boiler and the thermo-and-geared valves, so that when the user opens the faucet to a hot water side, the flow rate sensor detects the flow of cold water into the boiler and ignites the boiler such that heated water is smoothly supplied from the boiler into a hot water supply side of the corresponding thermo-and-geared valve, and in which a digital temperature compensating sensor is provided on a mixed water side of the thermo-and-geared valve corresponding to each control zone, and the thermo-and-geared valve is moved (operated) to the left or the right to adjust the temperature of water to the temperature preset by the user before the water is supplied to the user, thus preventing a delicate machine like the thermo-and-geared valve from malfunctioning, and in which a hot water storage tank 80 is provided on the hot water distribution pipe 20 through which hot water is discharged from the boiler 21 and prevents a sudden temperature deviation attributable to an event in which when the user uses mixed water after the circulation of cold water has been completed upon the temperature of the water having reached the preset temperature, cold water, which is discharged through the hot water supply pipe but is not yet heated while the boiler is igniting, enters the thermo-and-geared valve, so that cold water and hot water can flow smoothly while mixed water is circulating or not, thus making it possible to reliably supply hot/cold water that has a low temperature deviation, and in which the control panel indicates the completion of the ready to supply hot water to the user on a display and/or by a sound when the temperature of water reaches the preset temperature, thus making it more convenient to use, and which can prevent delicate machines like the thermo-and-geared valves from malfunctioning, can make the flow of cold water and hot water smooth while the mixed water is being circulated or not, thus making it possible to reliably supply hot/cold water of a low temperature deviation, and can indicate the completion of the ready to supply hot water to the user for the sake of the convenience of use.

Furthermore, the present invention relates to a hot/cold water supply system, in which when both a circulating-water pump start switch of a boiler 21 installed around the entrance of a bathroom and/or in one side of a faucet and a flow control lever of the faucet are operated such that the switch terminals of the boiler can be turned on and actuate a circulating-water pump of the boiler, the system circulates water both through a mixed water pipe and through a circulating water pipe and discharges mixed water having a temperature preset by a user using a water temperature control switch out of faucets installed in a public bath, a kitchen, a private bath, a laundry room, etc., and which can save water unlike a conventional hot/cold water supply system configured such that cold water must be removed from a pipeline until hot water having a desired temperature controlled by manipulating the control lever of an integrated hot/cold water faucet upwards, downwards, leftwards and rightwards comes out of the faucet, thus consuming an excessive amount of water. Further, the hot/cold water supply system can remarkably reduce the energy consumed in order to circulate hot water and can prevent a user from being burnt by hot water having an excessively high temperature after being heated by the boiler and directly discharged from the faucet by mis-operation of the control lever of the integrated hot/cold water faucet unlike the typical hot water using method of “Pipe freeze-proof and rapid hot water supply system” disclosed in Korean Patent Registration No. 10-0679605 filed by the applicant of the present invention in which, to allow a user to immediately use hot water discharged from a hot/cold/warm water faucet, separate circulating water pipes must be installed and both a boiler and a circulating-water pump must be repeatedly turned on and off all day in response to signals output from a temperature sensor sensing the various temperatures, thus consuming excessive energy. Furthermore, in the present invention, the problems experienced in the related art such that the temperature of hot water may frequently change in response to variations in the heating temperature of the boiler and may make a user feel discomfort while taking a bath or taking a shower bath can be solved. In addition, mixed warm water having a predetermined temperature can be distributed to water distributing valve boxes of respective control zones using one thermo valve formed by integrating a step motor with a thermostatic valve into a single structure, so that the present invention can supply mixed water having a desired temperature to a plurality of faucets using one thermo valve without separately mixing hot water with cold water for respective faucets. Moreover, when a user pushes a cold water/mixed water control switch, which is integrally provided on one side of a faucet, while using hot water or mixed water, the cold water/mixed water control valves of the water distributing valve boxes in respective control zones can be directly changed to cold water mode, so that a user can easily select cold water or mixed water as desired.

The present invention also relates to a hot/cold water supply system, in which a cleaning spray shower can be used instead of a conventional integrated type bidet in such a way that a mixed water pipe having a bellows double pipe structure is installed in a wall at a desired location outside a toilet bowl without installing a conventional integrated type bidet to the toilet bowl and a cleaning spray shower 45 having both a flow control button and a metal hose is installed on the surface of the wall after finishing the interior finish work such that the cleaning spray shower 45 is connected to the mixed water pipe, so that a user can wash his/her body after relieving himself (urinating or evacuating), using mixed water discharged from a valve box of either a public bath control zone or a private bath control zone according to the selection of the user and in which the cleaning spray shower 45 can be held on a cleaning spray shower holder installed on the wall so that the user who sits on the toilet can use the cleaning spray shower to wash his/her feet, wash the old and the weak or to clean the floor of the bathroom.

Further, the present invention further relates to a hot/cold water supply system, in which, when it is required to repair the pipes connected to respective control zones due to water leaking from the pipes or due to the requirement of having to change the existing pipes with new pipes, a worker can open the front door of an associated valve box and remove the hot water/mixed water pipe, the cold water pipe or the circulating water pipe from out of the bellows double pipes 25 connected to the valve box without damaging or breaking the interior finishing materials, so that the system of the present invention can provide a smart wall surface having a good appearance, in the same manner as that of Korean Patent Registration No. 10-0489440 and No. 10-0559161 which were filed by the applicant of the present invention.

### BACKGROUND ART

Conventional hot/cold water supply systems installed in apartments, studio apartments, hotels, houses, saunas, etc. directly supply cold water to a desired place or supply cold water and hot water heated by a boiler to a desired place. Such a hot/cold water supply system includes a faucet handle or a manual control valve which controls the temperature and flow rate of mixed water discharged from the spout of an integrated hot/cold water faucet. In the conventional hot/cold water supply system, the user must manipulate the faucet handle to a cold water side or a hot water side and touch mixed water discharged from the faucet with his/her hand to check the temperature of the mixture of water of cold water and hot water until it reaches the temperature desired by a user. Thus, a large amount of water that has remained in a pipe must be drained into a sewer until the temperature of water reaches the desired temperature. Also a lot of time is required until the mixed water of the desired temperature is discharged from the faucet.

The conventional hot/cold water supply system, in which the faucet handle or the manual control valve must be manually controlled to provide mixed water, is problematic in that it is difficult for a user to appropriately control the temperature of the discharged water although it depends on the skill of the user. Further, right after opening the faucet handle to use mixed water at the desired temperature, the water of a low temperature that remains in the hot water pipe and cold water remaining in the cold water pipe mix together, so that the discharged water in the initial stage of the operation of the system can not attain the desired temperature. Therefore, the user must control the faucet handle repeatedly to adjust the temperature of the discharged water while using the mixed water. Further, when a user carelessly manipulates the faucet handle such that the handle has been turned to the peak of the hot water mode or of the cold water mode, hot water having a very high temperature or cold water is undesirably discharged from the spout so that the user may be burned by the hot water or may be startled at the cold water. Another problem experienced in the conventional system resides in that the system must be provided with a faucet handle or a manual control valve for controlling the flow rate and temperature of discharged water, cold water supply pipes for supplying cold water, and hot water supply pipes for supplying hot water so that it is difficult to install them in a wall and the faucet handle spoils the appearance of the wall.

To overcome the above problems, the applicant of the present invention filed Korean Patent Application No. 10-2008-37541 entitled “Hot water supply system of a boiler and water boiler for supplying cold water or mixed water through faucets” and Korean Patent Application No. 10-2008-39690 entitled “Mixed water/hot/cold water supply system having improved temperature control function”. In these techniques, the water temperature can be easily controlled and mixed water having the desired temperature selected by a user can be immediately discharged from respective faucets 60 installed in a public bathroom, a kitchen, a private bathroom, a laundry room, etc. by controlling the operation of a water boiler and a circulating-water pump 31. Thus, the user can use mixed water without feeling any discomfort as a result of the temperature of the hot water frequently changing in response to variations in the amount of cold water that is used. The user can be prevented from being burned by hot water having a very high temperature. A circulating-water pump can be prevented from being uselessly operated, thus saving on water and energy. Furthermore, valve boxes provided in respective control zones have a bellows double pipe structure with respective flexible pipes, such as a cold water pipe, a hot water pipe, a mixed water pipe, a circulating water pipe inserted in respective bellows outer pipes such that the flexible pipes can be removed from the valve boxes, thus realizing easy repair of the flexible pipes and easy replacement of the existing flexible pipes with new pipes. The cold water/mixed water control valves installed in respective valve boxes can stop the flow of hot water and mixed water, so that it is easy to repair pipes in the case of faucets breaking or water leaking from the pipes extending to a washstand, a toilet bowl, a bathtub, a shower, a sink, an automatic washing machine, a hand washing facility, etc. A hot water/mixed water pipe for supplying hot water/mixed water and a cold water pipe for supplying cold water are installed on one pipeline, so that hot water, mixed water or cold water can be immediately discharged to the user, thus reducing the number of pipes and realizing the stability of a floor slab structure. A cleaning spray shower which has both a flow control button and a metal hose and is connected to a mixed water pipe is installed on the surface of a wall around a toilet bowl without installing a conventional integrated type bidet to the toilet bowl, so that a user can wash his/her body after relieving him or herself (i.e., urinating or evacuating) using mixed water distributed from the valve boxes 41 of a public bath control zone and a private bath control zone according to the selection of the user, and the cleaning spray shower held on a cleaning spray shower holder installed on the wall can be used for cleaning the floor of the toilet.

However, during testing over a long period of time of the hot/cold water supply systems for which a patent was applied for by the applicant of the present invention, several factors in need of improvement were found out. The present invention is proposed to improve these factors.

In these hot/cold water supply systems, when the faucet opens, hot water/mixed water is discharged from the faucet and the switch of a pressure sensor is turned off so that the circulating-water pump stops, thus interrupting the circulation of water through the circulating water pipe. When mixed water is continuously discharged out of the faucet, the boiler continuously operates so that a thermo-and-geared valve continuously discharges mixed water at a preset temperature. As soon as the flow control lever of the faucet is turned off, the operation of the boiler stops. However, if the user opens the faucet a long time after turning on a circulating-water pump start switch, a circulating-water pump operates without pause until the user opens the faucet, so that circulating water continuously circulates despite the temperature of the circulating water having already reached a desired temperature, thus wasting electricity.

Moreover, if water begins to be used a long time after the temperature of circulating water reaches the desired temperature, the temperature of the circulating water goes beyond the desired temperature because the boiler also continuously operates while the circulating-water pump continuously circulates the circulating water via the boiler. Thus, in the thermo-and-geared valve, cold water is mixed with the circulating water to control the temperature thereof. However, additional cold water cannot be supplied into the system unless the water in circulation is used. Hence, the temperature of the circulating water undesirably continuously increases. Meanwhile, if the temperature of water is set to different temperatures in the several control zones, in one of the control zones in which it is set to a comparatively low temperature, the temperature of water may be beyond the set temperature and increase to a comparatively high temperature that is set in another control zone. If the water begins to be used a long time later, the temperature of water may increase to a higher temperature.

In addition, there is a problem in that when the user uses mixed water after the circulation of cold water has completed upon the temperature of water reaching a preset temperature in one of the control zones, cold water, which is discharged through the hot water supply pipe but is not yet heated while the boiler is igniting, enters the thermo-and-geared valve, thus causing a sudden deviation in temperature.

To overcome the above problems, a technique was proposed, in which a time switch is provided so that when a duration preset by the time switch is exceeded, the operation of the boiler and the circulation of circulating water are automatically interrupted. However, as the duration preset by the time switch lengthens, the effect of the time switch is reduced. Even after the temperature of water has exceeded the preset temperature, it continuously increases until the duration set by the time switch is over. Thus, the temperature of water cannot be precisely controlled to the desired temperature.

Furthermore, there is no way of letting a user discern whether the temperature of mixed water reaches a preset temperature. Thus, after the duration of the time switch has finished, the user has no choice but to expect that it would reach the preset temperature.

### DISCLOSURE

### Technical Problem

Accordingly, the present invention has been made keeping in mind the above problems occurring in the prior art, and an object of the present invention is to provide a hot/cold water supply system for washstands or other water facilities installed in apartments, studio apartments, hotels, dwelling houses, saunas, public bathrooms, etc., which is configured such that cold water that has remained in a pipe re-circulates through a circulating water pipe and is re-supplied into and heated by a boiler rather than being discharged out of a faucet, and the temperature of water is adjusted in a thermo-and-geared valve to a temperature preset by a user so that water with a low temperature deviation can be supplied to the user, and in which a temperature control sensor is provided on the circulating water pipe connected to a circulating-water pump so that, when the temperature of the water is set in one of a plurality of control zones, the control part detects the corresponding control zone, and when the temperature of mixed water reaches the preset temperature, the circulating-water pump stops, thus preventing excessive pressure from being applied to the thermo-and-geared valve that has already been interrupted, thereby preventing the temperature of hot water to be supplied to the user from being higher than the preset temperature, and in which a flow rate sensor is provided on a cold water supply pipe before branching out into the boiler and the thermo-and-geared valves, so that when the user opens the faucet to a hot water side, the flow rate sensor detects the flow of cold water into the boiler and ignites the boiler such that heated water is smoothly supplied from the boiler into a hot water supply side of the corresponding thermo-and-geared valve, and in which a digital temperature compensating sensor is provided on a mixed water side of the thermo-and-geared valve corresponding to each control zone, and the thermo-and-geared valve is moved (operated) to the left or the right to adjust the temperature of water to the temperature preset by the user before the water is supplied to the user, thus preventing a delicate machine like the thermo-and-geared valve from malfunctioning, and in which a hot water storage tank 80 is provided on the hot water distribution pipe 20 through which hot water is discharged from the boiler 21 and prevents a sudden temperature deviation attributable to an event in which when the user uses mixed water after the circulation of cold water has been completed upon the temperature of the water having reached the preset temperature, cold water, which is discharged through the hot water supply pipe but is not yet heated while the boiler is igniting, enters the thermo-and-geared valve, so that cold water and hot water can flow smoothly while mixed water is circulating or not, thus making it possible to reliably supply hot/cold water that has a low temperature deviation, and in which the control panel indicates the completion of the ready to supply hot water to the user on a display and/or by a sound when the temperature of water reaches the preset temperature, thus making it more convenient to use, and which can prevent delicate machines like the thermo-and-geared valves from malfunctioning, can make the flow of cold water and hot water smooth while the mixed water is being circulated or not, thus making it possible to reliably supply hot/cold water of a low temperature deviation, and can indicate the completion of the ready to supply hot water to the user for the sake of the convenience of use.

### Technical Solution

In order to accomplish the above object, the present invention provides a hot/cold water supply system, including: a cold water supply pipe 10 arranged to a boiler 21 which heats cold water supplied from a boiler cold water supply pipe 2, the cold water supply pipe 10 branching off at a predetermined position thereof to distribute cold water; a hot water distribution pipe 20 distributing hot water heated by the boiler 21; a circulating water pipe 30 through which, of the hot water that has been distributed and supplied, hot water that has not been used is re-supplied into the boiler 21 by a circulating-water pump 31, re-heated by the boiler 21, and re-supplied to the hot water distribution pipe 20; a plurality of thermo-and-geared valves 22 provided on the hot water distribution pipe 20, each of the thermo-and-geared valves 22 integrally having a step motor and a thermostat valve and being configured such that cold water that branches off from the cold water supply pipe 10 is supplied into a first end of the thermo-and-geared valve 22, and hot water that is supplied from the hot water distribution pipe 20 is supplied into a second end of the thermo-and-geared valve 22; a plurality of control zones 40 and 40a having sub-control panels 52 disposed at appropriate positions on an entrance of a bathroom and/or around faucets, each of the sub-control panels 52 allowing a user to set a temperature of mixed water to be discharged from the corresponding faucet, wherein the boiler 21 and the thermo-and-geared valves 22 are controlled in such a way that when a temperature control switch 52a and a circulating-water pump start switch 52b of the corresponding sub-control panel 52 or a main control panel 51 that is installed at a predetermined position on the boiler 21 are operated, switches of the circulating-water pump 31 and the boiler 21 are turned on so that the circulating-water pump 31 and the boiler 21 are operated to circulate circulating water through a mixed water pipe 23 and the circulating water pipe 30, and mixed water of a temperature set by the corresponding temperature control switch 52a can be immediately discharged through the corresponding faucet 60 installed in a public bathroom, a kitchen, a private bathroom or a laundry room; the faucets 60 each having a flow control lever 61 and a cold water/mixed water control lever 62 which control flow of mixed water and cold water supplied from the corresponding control zone 40, 40a; and a control part 50 having a controller 53 which is electrically and electronically connected to the control zones 40 and 40a and the faucets 60 and controls operation of the boiler 21 and the circulating-water pump 31 and the preset temperature and a flow rate of the mixed water when using the hot water/mixed water, wherein the control zones 40 and 40a are connected in parallel to each other such that cold water pipes 46 supplying cold water to the respective control zones 40 and 40a are connected to each other in a loop style. The control part 50 includes a temperature control sensor 70 provided on the circulating water pipe 30, the temperature control sensor 70 stopping the circulating-water pump 31 when a temperature of the water reaches the preset temperature in the corresponding one of the control zones 40 and 40a.

The control part 50 may further include: a flow rate sensor 72 provided on the cold water supply pipe 10 before branching out into the boiler 21 and the thermo-and-geared valves 22, such that when the user uses mixed water, the flow rate sensor 72 detects a flow of cold water and stops the circulating-water pump 31 so that cold water is smoothly supplied to the boiler 21; and a backflow prevention valve 74 provided on an outlet side of the flow rate sensor 72 to enable the flow rate sensor 72 to reliably sense the flow rate of water in the cold water supply pipe 10 without producing sudden variations in a pressure in the cold water supply pipe 10 and in the flow rate of the water.

The hot/cold water supply system may further include a hot water storage tank 80 provided on the hot water distribution pipe 20 through which hot water is discharged from the boiler 21, the hot water storage tank 80 preventing a sudden temperature deviation resulting from an event in which when the user uses mixed water after the circulation of cold water has been completed upon the temperature of water reaching a preset temperature in the corresponding control zone 40, 40a, cold water, which is discharged through the hot water distribution pipe 20 but has not yet been heated while the boiler 21 is igniting, enters the thermo-and-geared valve 22.

The control part 50 may be configured such that an indication message is displayed on a display of the corresponding sub-control panel 52, a lamp 52c for calling a user's attention is provided on a side of the sub-control panel 52, or a speaker 52d for making an audio message is provided on a side of the sub-control panel 52, so that completion of the ready to supply hot water is able to be indicated to the user on the display and/or by a sound when the temperature of water reaches the preset temperature, thus promoting the convenience of use.

The control zones 40 and 40a may receive cold water and mixed water which are supplied at preset temperatures and supply mixed water of the same temperature to the plurality of faucets.

The hot/cold water supply system may further include a backflow prevention valve 74 provided on an outlet side of the circulating-water pump 31 just before a position at which the circulating water pipes 30 join with each other, the backflow prevention valve 74 preventing circulating water of one of the control zones 40 and 40a from flowing backwards towards another control zone 40, 40a when water is heated to different temperatures in the control zones 40 and 40a.

The hot/cold water supply system may further include a cleaning spray shower 45 installed on either of a left side or a right side of a toilet bowl, the cleaning spray shower 45 comprising a flow control lever and a nozzle connected to a metal hose so that mixed water of a preset temperature is discharged through the nozzle, thus allowing the user to use the cleaning spray shower 45 for washing his/her body after relieving him or herself or for washing a floor of a bathroom.

### Advantageous Effects

The effects of the present invention are as follows.

The present invention provides a hot/cold water supply system with an improved control part. The hot/cold water supply system is used for washstands or other water facilities installed in apartments, studio apartments, hotels, dwelling houses, saunas, public bathrooms, etc. The system is configured such that cold water that has remained in a pipe re-circulates through a circulating water pipe and is re-supplied into and heated by a boiler rather than being discharged out of a faucet, and the temperature of water is adjusted in a thermo-and-geared valve to a temperature preset by a user so that water with a low temperature deviation can be supplied to the user. A temperature control sensor is provided on the circulating water pipe connected to a circulating-water pump. Thus, when the temperature of water is set in one of a plurality of control zones, the control part detects the corresponding control zone, and when the temperature of mixed water reaches the preset temperature, the circulating-water pump stops, thus preventing excessive pressure from being applied to the thermo-and-geared valve that has already been interrupted, thereby preventing the temperature of hot water that is supplied to the user from going above the preset temperature. A flow rate sensor is provided on a cold water supply pipe before branching out into the boiler and the thermo-and-geared valves, so that when the user opens the faucet to a hot water side, the flow rate sensor detects the flow of cold water into the boiler and ignites the boiler such that heated water is smoothly supplied from the boiler into a hot water supply side of the corresponding thermo-and-geared valve. A digital temperature compensating sensor is provided on a mixed water side of the thermo-and-geared valve corresponding to each control zone, and the thermo-and-geared valve is moved (operated) to the left or the right to adjust the temperature of water to the temperature preset by the user before the water is supplied to the user, thus preventing a delicate machine like the thermo-and-geared valve from malfunctioning. A hot water storage tank 80 is provided on the hot water distribution pipe 20 through which hot water is discharged from the boiler 21 and prevents a sudden deviation in temperature attributable to an event in which when the user uses mixed water after the circulation of cold water has completed after the temperature of water has reached the preset temperature, cold water, which is discharged through the hot water supply pipe but is not yet heated while the boiler is igniting, enters the thermo-and-geared valve. Thus, cold water and hot water can smoothly flow while mixed water is circulating or not, thereby making it possible to reliably supply hot/cold water of a low temperature deviation. The control panel indicates the completion of the ready to supply hot water to the user on a display and/or by a sound when the temperature of water reaches the preset temperature, thus making it more convenient to use. Therefore, the system of the present invention can prevent delicate machines like the thermo-and-geared valves from malfunctioning and make the flow of cold water and hot water smooth while the mixed water is circulating or not, thus making it possible to reliably supply hot/cold water that has a low temperature deviation. Also, the system can indicate the completion of the ready to supply hot water to the user, thus making it more convenient to use.

### DESCRIPTION OF DRAWINGS

FIG. 1 is a schematic view showing a conventional hot/cold water supply system;

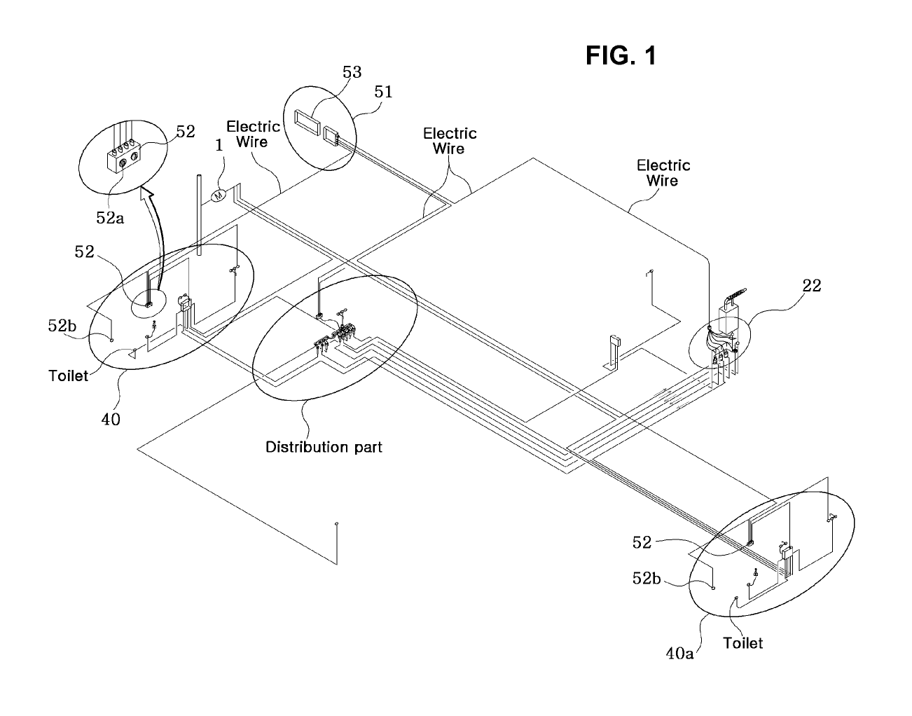

FIG. 2 is a schematic view showing a control part of the conventional hot/cold water supply system;

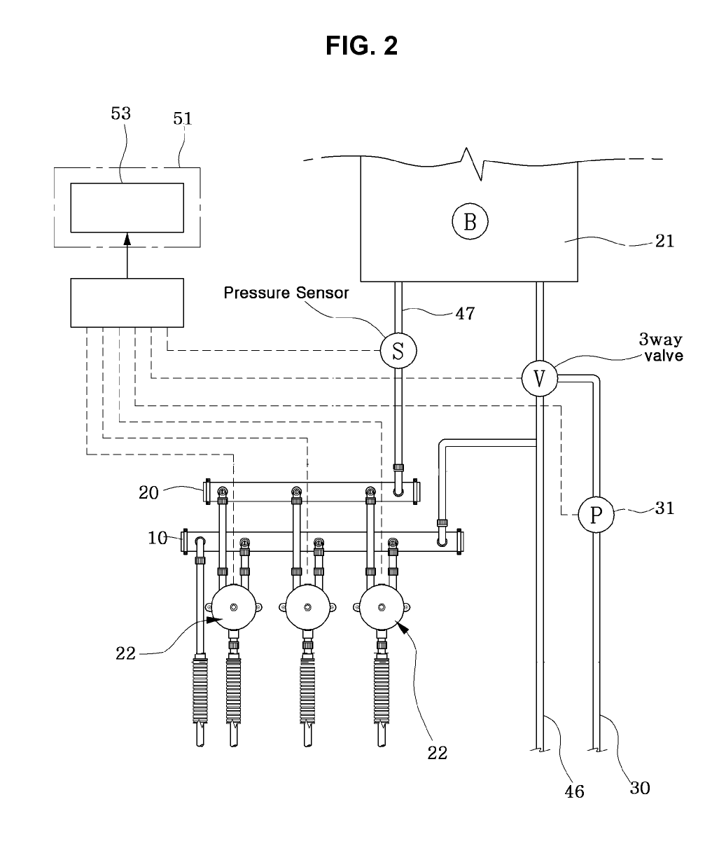

FIG. 3 is a schematic view showing a hot/cold water supply system, according to an embodiment of the present invention;

FIG. 4 is a schematic view showing a control part of the hot/cold water supply system according to the present invention;

FIG. 5 is a schematic view showing a control part of a hot/cold water supply system which is provided with a boiler having a hot water storage tank;

FIG. 6 is of views showing several examples of a sub-control panel of the hot/cold water supply system according to the present invention; and

FIG. 7 is an enlarged perspective view of a fluid branch pipe of the hot/cold water supply system according to the present invention.

<Description of the Reference Numerals in the Drawings>

| | |
|---|---|
| 1: water meter | 2: boiler cold water supply pipe |
| 3: water supply pipe | 10: cold water supply pipe |
| 20: hot water distribution pipe | 21: boiler |
| 22: thermo-and-geared valve | 23: mixed water pipe |
| 30: circulating water pipe | 31: circulating-water pump |
| 40, 40a: control zone | 41: valve box |
| 42: fluid branch pipe | 43: motor |
| 44: cold water/mixed water | |
| control valve | |
| 45: cleaning spray shower | |
| 46: cold water pipe | 47: hot water pipe |
| 50: control part | 51: main control panel |
| 52: sub-control panel | 52a: temperature control switch |
| 52b: circulating-water pump | 52c: lamp |
| start switch | |
| 52d: speaker | 53: controller |
| 54: digital temperature | 60: faucet |
| compensating sensor | |
| 61: flow control lever | 62: water/mixed water control lever |
| 70: temperature control sensor | 72: flow rate sensor |
| 74: backflow prevention valve | 80: hot water storage tank |

### BEST MODE

Hereinafter, the present invention will be described in detail with reference to the attached drawings.

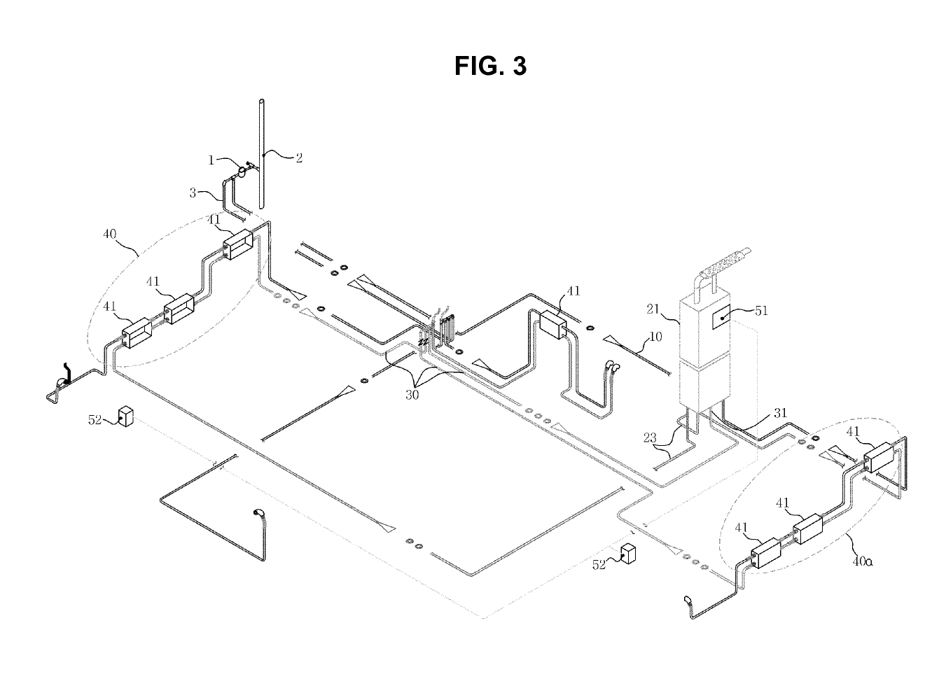

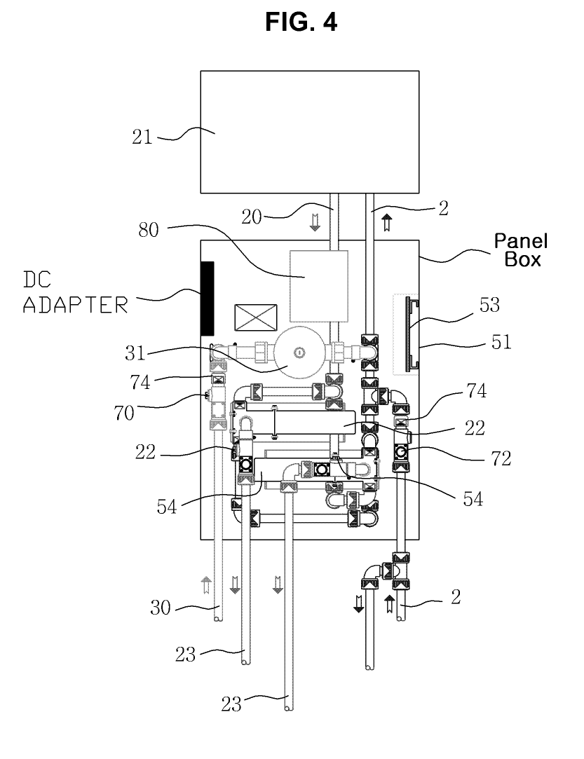

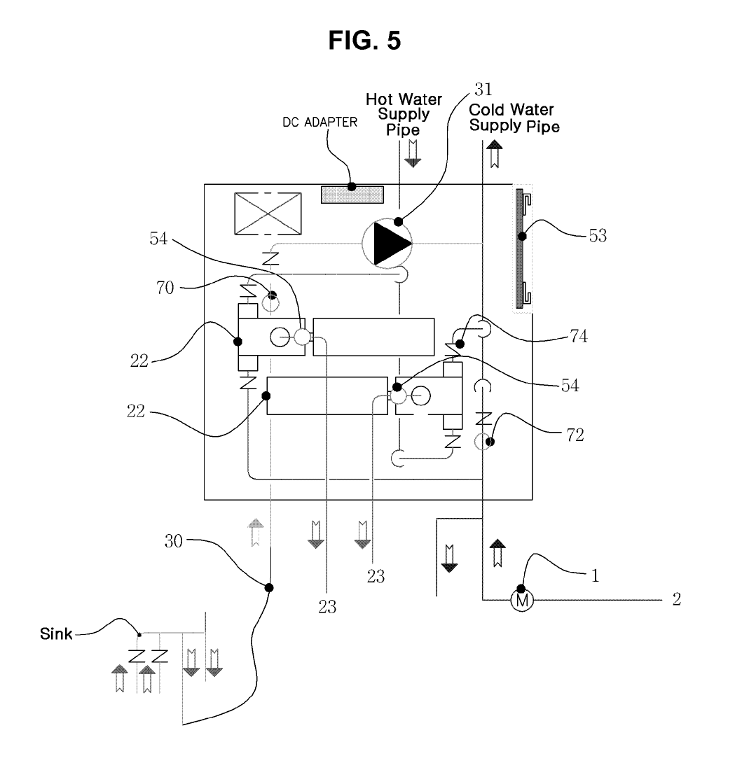

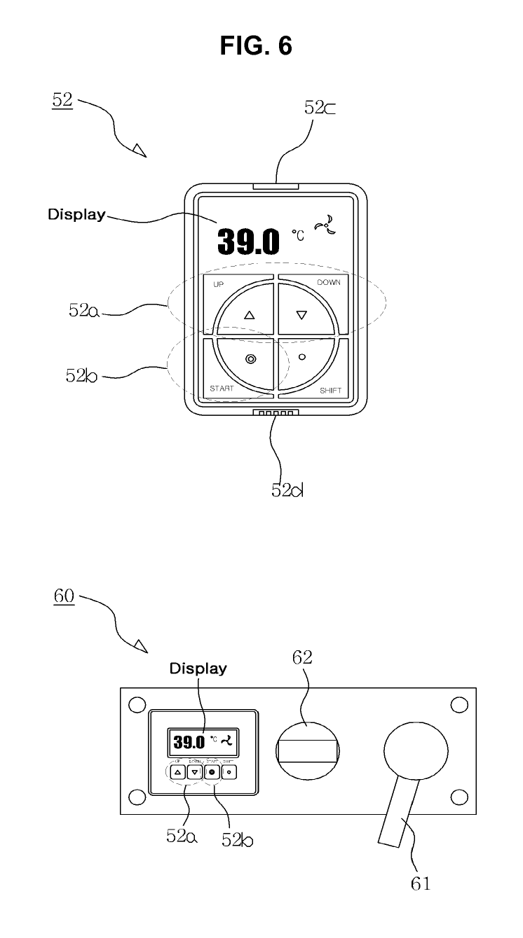

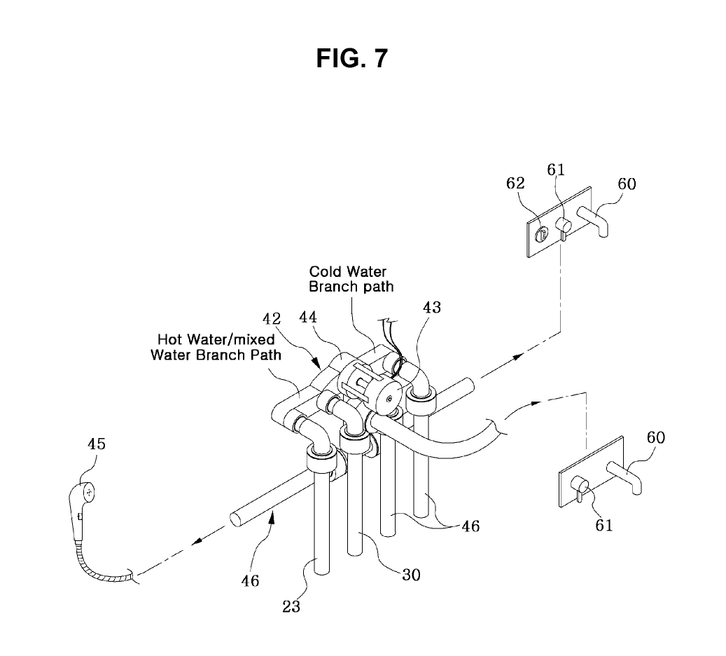

FIG. 3 is a schematic view showing a hot/cold water supply system, according to an embodiment of the present invention. FIG. 4 is a schematic view showing a control part of the hot/cold water supply system according to the present invention. FIG. 5 is a schematic view showing a control part of a hot/cold water supply system which is provided with a boiler having a hot water storage tank. FIG. 6 is of views showing several examples of a sub-control panel of the hot/cold water supply system according to the present invention. FIG. 7 is an enlarged perspective view of a fluid branch pipe of the hot/cold water supply system according to the present invention.

The present invention provides a hot/cold water supply system for washstands or other water facilities installed in apartments, studio apartments, hotels, dwelling houses, saunas, public bathrooms, etc. The system is configured such that cold water that has remained in a pipe re-circulates through a circulating water pipe and is re-supplied into and heated by a boiler rather than being discharged out of a faucet, and the temperature of water is adjusted in a thermo-and-geared valve to a temperature preset by a user so that water with a low temperature deviation can be supplied to the user. A temperature control sensor is provided on the circulating water pipe connected to a circulating-water pump. Thus, when the temperature of the water is set in one of a plurality of control zones, the control part detects the corresponding control zone, and when the temperature of mixed water reaches the preset temperature, the circulating-water pump stops, thus preventing excessive pressure from being applied to the thermo-and-geared valve that has already been interrupted, thereby preventing the temperature of hot water to be supplied to the user from being higher than the preset temperature. A flow rate sensor is provided on a cold water supply pipe before branching out into the boiler and the thermo-and-geared valves, so that when the user opens the faucet to a hot water side, the flow rate sensor detects the flow of cold water into the boiler and ignites the boiler such that heated water is smoothly supplied from the boiler into a hot water supply side of the corresponding thermo-and-geared valve. A digital temperature compensating sensor is provided on a mixed water side of the thermo-and-geared valve corresponding to each control zone, and the thermo-and-geared valve is moved (operated) to the left or the right to adjust the temperature of water to the temperature preset by the user before the water is supplied to the user, thus preventing a delicate machine like the thermo-and-geared valve from malfunctioning. A hot water storage tank 80 is provided on the hot water distribution pipe 20 through which hot water is discharged from the boiler 21 and prevents a sudden temperature deviation attributable to an event in which when the user uses mixed water after the circulation of cold water has been completed upon the temperature of the water having reached the preset temperature, cold water, which is discharged through the hot water supply pipe but is not yet heated while the boiler is igniting, enters the thermo-and-geared valve. Thus, cold water and hot water can flow smoothly while mixed water is circulating or not, thereby making it possible to reliably supply hot/cold water that has a low temperature deviation. The control panel indicates the completion of the ready to supply hot water to the user on a display and/or by a sound when the temperature of water reaches the preset temperature, thus making it more convenient to use. Therefore, the system of the present invention can prevent delicate machines like the thermo-and-geared valves from malfunctioning and make the flow of cold water and hot water smooth while the mixed water being circulated or not, thus making it possible to reliably supply hot/cold water of a low temperature deviation. Also, the system can indicate the completion of the ready to supply hot water to the user, thus making it more convenient to use.

The improved control part 50 of the present invention is characterized in that the temperature control sensor 70 is provided on the circulating water pipe 30 connected to the circulating-water pump 31.

Thereby, when the temperature of water in one of the control zones 40 and 40a reaches a preset temperature, the circulating-water pump 31 stops so that excessive pressure can be prevented from being applied to the thermo-and-geared valve 22 that has already been interrupted, and thus the temperature of hot water to be supplied to the user can be prevented from going above the temperature preset by the user. The thermo-and-geared valve 22 can also be prevented from malfunctioning.

Furthermore, the control part 50 of the present invention includes a liquid crystal display and a speaker which are provided on each sub-control panel 52, and a flow rate sensor which is provided on the cold water supply pipe 10 before branching out into the boiler 21 and the corresponding thermo-and-geared valve 22. Thus, when the remaining water circulates or the user uses mixed water of a preset temperature, a light is turned ON/OFF on the corresponding sub-control panel 52. When the temperature of mixed water reaches the preset temperature, it is indicated to the user on a display and/or with a sound that the ready to supply hot water has concluded.

Thanks to this structure of the control part 50, it is not necessary for the user to frequently check whether hot water of the desired temperature is ready, because whether hot water has been ready is indicated to the user by an image and/or a sound so that the user can easily discern it and rapidly use the hot water as soon as it is ready. Therefore, the present invention can prevent hot water that has been heated to the preset temperature from cooling, thus avoiding the operation of re-heating water which wastes energy.

In addition, the present invention is characterized in that a hot water storage tank is provided on the hot water distribution pipe 20 through which heated water is discharged from the boiler 21.

The reason for this is to prevent a sudden temperature deviation attributable to an event in which when the user uses mixed water after the circulation of cold water has been completed upon the temperature of water reaching a preset temperature in the corresponding control zone 40, 40a, cold water, which is discharged through the hot water distribution pipe 20 but is not yet heated while the boiler 21 is igniting, enters the thermo-and-geared valve 22.

Hereinafter, preferred embodiments of the present invention will be described in detail. The preferred embodiments will be disclosed for illustrative purposes to provide a clear understanding of the present invention, and the present invention must not be regarded as being limited to the preferred embodiments.

### First Embodiment

As shown in FIG. 3, in a hot/cold water supply system according to the present invention, a cold water supply pipe 10 is arranged to a boiler 21 which heats cold water supplied from a boiler cold water supply pipe 2. The cold water supply pipe 10 branches off under the boiler 21 and distributes cold water to a plurality of thermo-and-geared valves 22 and control zones 40 and 40a. A hot water distribution pipe 20 distributes hot water that has been heated by the boiler 21. The thermo-and-geared valves 22 are provided on the hot/cold water distribution pipe 20. Each thermo-and-geared valve 22 integrally has a step motor and a thermostat valve. Cold water that branches off from the cold water supply pipe 10 is supplied into a first end of the thermo-and-geared valve 22, and hot water that is supplied from the hot water distribution pipe 20 is supplied into a second end of the thermo-and-geared valve 22. A plurality of control zones 40 and 40a are provided. In the control zones 40 and 40a, sub-control panels 52 are disposed at appropriate positions on an entrance of a bathroom and/or around faucets. Each sub-control panel 52 allows the user to set the temperature of mixed water to be discharged. A main control panel 51 is installed at a predetermined position on the boiler 21. In each control zone 40, 40a, the boiler 21 and the thermo-and-geared valves 22 are controlled in such a way that when a temperature control switch 52a and a circulating-water pump start switch 52b of the corresponding sub-control panel 52 or the main control panel 51 are operated, a switch of the circulating-water pump 31 is turned on so that a boiler 21 is operated to circulate cold water remaining in pipes through a mixed water pipe 23 and a circulating water pipe 30, and mixed water of a temperature set by the temperature control switch 52a of each zone can be immediately discharged through a corresponding faucet 60 installed in a public bathroom, a kitchen, a private bathroom or a laundry room. Each faucet 60 has a flow control lever 61 and a cold water/mixed water control lever 62 which control the flow of mixed water and cold water supplied from the corresponding control zone 40, 40a. A control part 50 has a controller 53 which is electrically and electronically connected to the control zones 40 and 40a and the faucets 60 and controls the operation of the boiler 21 and the circulating-water pump 31 and the preset temperature and the flow rate of the mixed water when using the hot water/mixed water. The control zones 40 and 40a are connected in parallel to each other such that cold water pipes 46 supplying cold water to the respective control zones 40 and 40a are connected to each other in a loop style.

Furthermore, each control zone 40, 40a has a valve box 41 which includes a fluid branch pipe 42 provided with a cold water/mixed water control valve 44 for receiving cold water and mixed water that are at preset temperatures and controllably distributing water by operating a motor 43.

As shown in FIGS. 4 and 5, the control part 50 includes a flow rate sensor 72 which is provided on the cold water supply pipe 10 before branching out into the boiler 21 and the thermo-and-geared valves 22. When the user uses mixed water, the flow rate sensor 72 detects the flow of cold water and stops the circulating-water pump 31 so that water can stop circulating through the circulating water pipe 30 and cold water can be smoothly supplied to the boiler 21. Further, a backflow prevention valve 74 is provided on an outlet side of the flow rate sensor 72 to enable the flow rate sensor 72 to sense the flow rate of water in the cold water supply pipe 10 without creating a sudden variation in the pressure or flow rate of water. Thereby, the flow rate sensor 72 can be prevented from being undesirably operated by the backflow of cold water which may occur.

Moreover, for the convenience of use, the control part 50 functions to indicate completion of the ready to supply hot water to the user on a display and/or with a sound when the temperature of the water reaches a preset temperature. For this, in an embodiment, an indication message is displayed on the display of the corresponding sub-control panel 52. Also, a lamp 52c which gets a user's attention is provided on a side of the sub-control panel 52, and a speaker 52d which produces an audio message is provided on another side of the sub-control panel 52.

Therefore, after the user sets a desired temperature of hot water using the sub-control panel 52 and turns on the circulating-water pump start switch 52b, it is not necessary to frequently check whether hot water of the desired temperature is ready, because it is easy to notify the user with the display of the sub-control panel 52 and/or an audio message that the hot water is now ready. Thus, the present invention can make it more convenient to use.

The hot/cold water supply system of the present invention further includes a hot water storage tank 80 which is provided on the hot water distribution pipe 20 through which hot water is discharged from the boiler 21. The hot water storage tank functions to prevent a sudden deviation in temperature attributable to an event in which when the user uses mixed water after the circulation of cold water has been completed upon the temperature of water reaching a preset temperature in the corresponding control zone 40, 40a, cold water, which is discharged through the hot water distribution pipe 20 but is not yet heated while the boiler 21 is igniting, enters the thermo-and-geared valve 22.

Furthermore, a backflow prevention valve 74 is provided on the outlet side of the circulating-water pump 31 just before a position at which the circulating water pipes 30 joins with each other. The backflow prevention valve 74 prevents circulating water of either of the control zone 40 or 40a from flowing backwards towards the other control zone 40, 40a when water is heated to different temperatures in the control zones 40 and 40a.

Further, a cleaning spray shower 45 is installed on either the left or the right side of a toilet bowl. The cleaning spray shower 45 includes a flow control lever and a nozzle which is connected to a metal hose so that mixed water of a preset temperature is discharged through the nozzle. The user can use the cleaning spray shower 45 to wash the body of the user after relieving oneself, such as urinating or evacuating, wash his/her feet after sitting on the toilet, wash the old and the weak or clean the floor of the bathroom.

The operation of the improved control part 50 according to the present invention will be described.

First, the user who wants to use hot water sets a desired temperature on the corresponding sub-control panel 52. Once the desired temperature has been set a single time, it is maintained until the user resets it, except in the case where the desired temperature is set to a high temperature of 40° C. or more.

After the desired temperature has been set, the user turns on the circulating-water pump start switch 52b so that water begins to circulate. Then, cold remaining water in the pipe of the corresponding control zone is supplied into the boiler 21 by the circulating-water pump 31 through the circulating water pipe 30 and is heated by the boiler 21 before entering the corresponding thermo-and-geared valve 22.

While the circulation continues, the temperature of the circulating water increases, and a digital temperature compensating sensor 54 which is disposed at an outlet side of the thermo-and-geared valve 22 controls the valve until the temperature of the circulating water reaches the desired temperature.

When the temperature control sensor 70 which measures the temperature of the circulating water that passes through the circulating-water pump 31 detects that the circulating water has reached the desired temperature, the corresponding switch is turned off so that the circulating-water pump 31 stops and the circulation process is completed.

Upon completion of the circulation process, an alarm message is indicated on the display of the sub-control panel 52 or by a sound to let the user know that hot water of the desired temperature is now ready. Referring to FIG. 6, a fan-shaped indication (pertaining to the circulating-water pump) is shown on the top right hand corner of the sub-control panel 52. When the circulating-water pump is not in operation, the fan-shaped indication does not move. The fan-shaped indication rotates when the circulating-water pump is being operated. When the temperature of the circulating water reaches the preset temperature, the temperature control sensor 70 detects it and turns off the switch, and the fan-shaped indication also stops. Also, the sub-control panel 52 may be configured such that when the circulating-water pump is being operated, backlighting of the display is turned on, and when hot water has been ready, the backlighting of the display is turned off. Furthermore, when hot water has become ready, the lamp 52c which is disposed on the medial portion of the upper end of the sub-control panel 52 blinks, and the speaker 52d which is disposed on the lower end thereof makes a sound, for example, “hot water ready”, and repeats it several times.

When the user opens the faucet to use hot water, if the flow rate sensor 72 which is provided on the cold water supply pipe 10 just before a position at which it branches out into the boiler 21 and the thermo-and-geared valve 22 detects the flow of cold water, the switch is turned off so that the circulating-water pump 31 stops. This operation can prevent an event in which when the user opens the faucet before mixed water reaches the preset temperature, the circulating-water pump 31 that is still being operated sends the mixed water into the circulating water pipe 30 rather than discharging it out of the faucet 60. In any case, if the user uses the faucet, the switch is turned off. Thus, the circulating-water pump 31 stops so that the circulation process is interrupted. Hot water that has passed through the boiler 21 enters the thermo-and-geared valve 22 and becomes mixed water of a desired temperature before it is supplied to the corresponding control zone 40, 40a.

As described above, thanks to the improved control part 50, the user can easily obtain hot water of a desired temperature and a low temperature deviation. Also, when the temperature of water reaches the desired temperature, the control part 50 easily enables the user be aware of it. Even if the user uses the faucet before the temperature of water reaches the desired temperature, the temperature of hot water can be prevented from suddenly varying.

Furthermore, in one of the control zones 40 and 40a, after the temperature of water reaches a desired temperature and the temperature control sensor 70 stops the circulating-water pump 31 and the boiler 21, when the user opens the faucet to use mixed water, the thermo-and-geared valve 22 receives hot water from the boiler 21 and cold water from the cold water supply pipe 10, mixes the hot water with the cold water, and forms mixed water of a preset temperature before sending the mixed water to the corresponding control zone. However, upon opening the faucet to use mixed water, cold water is supplied into the boiler 21 but is not sufficiently heated while the boiler 21 ignites. The cold water that is not yet heated is supplied into the thermo-and-geared valve 22 through the hot water distribution pipe 20. Hence, there may be sudden temperature deviations in the water.

To mitigate the problem of temperature deviation, a hot water storage tank 80 of a capacity ranging from about 2 liters to about 5 liters is provided on the hot water distribution pipe 20 at the outlet side of the boiler 21. When the user opens the faucet to use mixed water, cold water that has passed through the boiler 21 but not yet been heated enters the hot water storage tank 80, and mixed water which has been stored in the hot water storage tank 80 is supplied to the thermo-and-geared valve 22 through the hot water distribution pipe 20, thus mitigating the above problem.

In the drawings, reference numeral 1 denotes a water meter.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The effects of the present invention having the above-mentioned construction and operation are as follows.

The present invention provides a hot/cold water supply system with an improved control part. The hot/cold water supply system is used for washstands or other water facilities installed in apartments, studio apartments, hotels, dwelling houses, saunas, public bathrooms, etc. The system is configured such that cold water that has remained in a pipe re-circulates through a circulating water pipe and is re-supplied into and heated by a boiler rather than being discharged out of a faucet, and the temperature of water is adjusted in a thermo-and-geared valve to a temperature preset by a user so that water with a low temperature deviation can be supplied to the user. A temperature control sensor is provided on the circulating water pipe connected to a circulating-water pump. Thus, when the temperature of water is set in one of a plurality of control zones, the control part detects the corresponding control zone, and when the temperature of mixed water reaches the preset temperature, the circulating-water pump stops, thus preventing excessive pressure from being applied to the thermo-and-geared valve that has already been interrupted, thereby preventing the temperature of hot water that is supplied to the user from going above the preset temperature. A flow rate sensor is provided on a cold water supply pipe before branching out into the boiler and the thermo-and-geared valves, so that when the user opens the faucet to a hot water side, the flow rate sensor detects the flow of cold water into the boiler and ignites the boiler such that heated water is smoothly supplied from the boiler into a hot water supply side of the corresponding thermo-and-geared valve. A digital temperature compensating sensor is provided on a mixed water side of the thermo-and-geared valve corresponding to each control zone, and the thermo-and-geared valve is moved (operated) to the left or the right to adjust the temperature of water to the temperature preset by the user before the water is supplied to the user, thus preventing a delicate machine like the thermo-and-geared valve from malfunctioning. A hot water storage tank 80 is provided on the hot water distribution pipe 20 through which hot water is discharged from the boiler 21 and prevents a sudden deviation in temperature attributable to an event in which when the user uses mixed water after the circulation of cold water has been completed after the temperature of water has reached the preset temperature, cold water, which is discharged through the hot water supply pipe but is not yet heated while the boiler is igniting, enters the thermo-and-geared valve. Thus, cold water and hot water can smoothly flow while mixed water is circulating or not, thereby making it possible to reliably supply hot/cold water of a low temperature deviation. The control panel indicates the completion of the ready to supply hot water to the user on a display and/or by a sound when the temperature of water reaches the preset temperature, thus making it more convenient to use. Therefore, the system of the present invention can prevent delicate machines like the thermo-and-geared valves from malfunctioning and make the flow of cold water and hot water smooth while the mixed water is circulating or not, thus making it possible to reliably supply hot/cold water that has a low temperature deviation. Also, the system can indicate the completion of the ready to supply hot water to the user, thus making it more convenient to use.

1. A hot/cold water supply system, comprising: a cold water supply pipe (10) arranged to a boiler (21) which heats cold water supplied from a boiler cold water supply pipe (2), the cold water supply pipe (10) branching off at a predetermined position thereof to distribute cold water; a hot water distribution pipe (20) distributing hot water heated by the boiler (21); a circulating water pipe (30) through which, of the hot water that has been distributed and supplied, hot water that has not been used is re-supplied into the boiler (21) by a circulating-water pump (31), re-heated by the boiler (21), and re-supplied to the hot water distribution pipe (20); a plurality of thermo-and-geared valves (22) provided on the hot water distribution pipe (20), each of the thermo-and-geared valves (22) integrally having a step motor and a thermostat valve and being configured such that cold water that branches off from the cold water supply pipe (10) is supplied into a first end of the thermo-and-geared valve (22), and hot water that is supplied from the hot water distribution pipe (20) is supplied into a second end of the thermo-and-geared valve (22); a plurality of control zones (40) and (40a) having sub-control panels (52) disposed at appropriate positions on an entrance of a bathroom and/or around faucets, each of the sub-control panels (52) allowing a user to set a temperature of mixed water to be discharged from the corresponding faucet, wherein the boiler (21) and the thermo-and-geared valves (22) are controlled in such a way that when a temperature control switch (52a) and a circulating-water pump start switch (52b) of the corresponding sub-control panel (52) or a main control panel (51) that is installed at a predetermined position on the boiler (21) are operated, switches of the circulating-water pump (31) and the boiler (21) are turned on so that the circulating-water pump (31) and the boiler 21 are operated to circulate circulating water through a mixed water pipe (23) and the circulating water pipe (30), and mixed water of a temperature set by the corresponding temperature control switch (52a) can be immediately discharged through the corresponding faucet 60 installed in a public bathroom, a kitchen, a private bathroom or a laundry room; the faucets (60) each having a flow control lever (61) and a cold water/mixed water control lever (62) which control flow of mixed water and cold water supplied from the corresponding control zone (40), (40a); and a control part (50) having a controller (53) which is electrically and electronically connected to the control zones (40) and (40a) and the faucets (60) and controls operation of the boiler (21) and the circulating-water pump (31) and the preset temperature and a flow rate of the mixed water when using the hot water/mixed water, wherein the control zones (40) and (40a) are connected in parallel to each other such that cold water pipes (46) supplying cold water to the respective control zones (40) and (40a) are connected to each other in a loop style,
wherein the control part (50) comprises:
a temperature control sensor (70) provided on the circulating water pipe (30), the temperature control sensor (70) stopping the circulating-water pump (31) when a temperature of the water reaches the preset temperature in the corresponding one of the control zones (40) and (40a).

2. The hot/cold water supply system according to claim 1, wherein the control part (50) further comprises:
a flow rate sensor (72) provided on the cold water supply pipe (10) before branching out into the boiler (21) and the thermo-and-geared valves (22), such that when the user uses mixed water, the flow rate sensor (72) detects a flow of cold water and stops the circulating-water pump (31) so that cold water is smoothly supplied to the boiler (21); and
a backflow prevention valve (74) provided on an outlet side of the flow rate sensor (72) to enable the flow rate sensor (72) to reliably sense the flow rate of water in the cold water supply pipe (10) without producing sudden variations in a pressure in the cold water supply pipe (10) and in the flow rate of the water.

3. The hot/cold water supply system according to claim 1, further comprising:
a hot water storage tank (80) provided on the hot water distribution pipe (20) through which hot water is discharged from the boiler (21), the hot water storage tank (80) preventing a sudden temperature deviation resulting from an event in which when the user uses mixed water after the circulation of cold water has been completed upon the temperature of water reaching a preset temperature in the corresponding control zone (40), (40a), cold water, which is discharged through the hot water distribution pipe (20) but has not yet been heated while the boiler (21) is igniting, enters the thermo-and-geared valve (22).

4. The hot/cold water supply system according to claim 1, wherein the control part (50) is configured such that an indication message is displayed on a display of the corresponding sub-control panel (52), a lamp (52c) for calling a user's attention is provided on a side of the sub-control panel (52), or a speaker (52d) for making an audio message is provided on a side of the sub-control panel (52), so that completion of the ready to supply hot water is able to be indicated to the user on the display and/or by a sound when the temperature of water reaches the preset temperature, thus promoting the convenience of use.

5. The hot/cold water supply system according to claim 1, wherein the control zones (40) and (40a) receive cold water and mixed water which are supplied at preset temperatures and supply mixed water of the same temperature to the plurality of faucets.

6. The hot/cold water supply system according to claim 2, further comprising:
a backflow prevention valve (74) provided on an outlet side of the circulating-water pump (31) just before a position at which the circulating water pipes (30) join with each other, the backflow prevention valve (74) preventing circulating water of one of the control zones (40) and (40a) from flowing backwards towards another control zone (40), (40a) when water is heated to different temperatures in the control zones (40) and (40a).

7. The hot/cold water supply system according to claim 6, further comprising:
a cleaning spray shower (45) installed on either of a left side or a right side of a toilet bowl, the cleaning spray shower (45) comprising a flow control lever and a nozzle connected to a metal hose so that mixed water of a preset temperature is discharged through the nozzle, thus allowing the user to use the cleaning spray shower (45) for washing his/her body after relieving him or herself or for washing a floor of a bathroom.

8. The hot/cold water supply system according to claim 2, further comprising:
a hot water storage tank (80) provided on the hot water distribution pipe (20) through which hot water is discharged from the boiler (21), the hot water storage tank (80) preventing a sudden temperature deviation resulting from an event in which when the user uses mixed water after the circulation of cold water has been completed upon the temperature of water reaching a preset temperature in the corresponding control zone (40), (40a), cold water, which is discharged through the hot water distribution pipe (20) but has not yet been heated while the boiler (21) is igniting, enters the thermo-and-geared valve (22).

9. The hot/cold water supply system according to claim 2, wherein the control part (50) is configured such that an indication message is displayed on a display of the corresponding sub-control panel (52), a lamp (52c) for calling a user's attention is provided on a side of the sub-control panel (52), or a speaker (52d) for making an audio message is provided on a side of the sub-control panel (52), so that completion of the ready to supply hot water is able to be indicated to the user on the display and/or by a sound when the temperature of water reaches the preset temperature, thus promoting the convenience of use.

10. The hot/cold water supply system according to claim 2, wherein the control zones (40) and (40a) receive cold water and mixed water which are supplied at preset temperatures and supply mixed water of the same temperature to the plurality of faucets.
